(19) United States
(12) Patent Application Publication
(10) Pub. No.: US 2014/0365205 A1
(43) Pub. Date: Dec. 11, 2014

(54) INFORMATION PROCESSING SYSTEM, INFORMATION PROCESSOR, INFORMATION PROCESSING METHOD, PROGRAM, AND INFORMATION STORAGE MEDIA

(71) Applicant: Sony Computer Entertainment Inc., Tokyo (JP)

(72) Inventor: Eiichi NISHINA, Tokyo (JP)

(73) Assignee: Sony Computer Entertainment Inc., Tokyo (JP)

(21) Appl. No.: 14/285,814

(22) Filed: May 23, 2014

(30) Foreign Application Priority Data
Jun. 6, 2013 (JP) 2013-120272

(51) Int. Cl. G06F 17/27

(52) U.S. Cl. CPC G06F 17/275
USPC 704/8

(57) ABSTRACT

There is provided an information processing system, an information processor, an information processing method, a program, and an information storage media capable of striking a balance between ensuring readability of transmitted information and keeping traffic to a minimum during transmission of the information. Disclosed herein is the information processing system including: a transmitter; and a receiver. The transmitter has a language determination section adapted to determine a plurality of languages based on a setting of the transmitter and a transmission section adapted to transmit a plurality of pieces of data, each written in one of the plurality of determined languages that are different from each other. The receiver has a reception section adapted to receive the data and a display control section adapted to display the data written in at least one of the plurality of languages.

### BACKGROUND

The present disclosure relates to an information processing system, an information processor, an information processing method, a program, and an information storage media.

A game console exists that transmits a message about a game played by a user to other user when an event occurs in the game (refer to Japanese Patent Laid-open Publication No. 2012-152395).

### SUMMARY

Here, the language readable by the message transmitting user may be different from that readable by the message receiving user. This is highly likely to occur particularly in European areas. In this case, if the user of the message transmitting game console transmits a message in his or her language, the user of the message receiving game console may have difficulty reading the message. Therefore, it would be convenient for the user of the message receiving game console if a plurality of messages indicating the same contents and written in different languages were sent, and the language in which to display the message could be selected on the message receiving game console.

However, assuming that a plurality of messages written in different languages are sent, the larger the number of target languages, the larger the size of messages. This leads to increased traffic at the time of message transmission.

In light of the foregoing, it is desirable to provide an information processing system, an information processor, an information processing method, a program, and an information storage media capable of striking a balance between ensuring readability of transmitted information and keeping traffic to a minimum during transmission of the information.

According to an embodiment of the present disclosure, there is provided an information processing system that includes a transmitter and a receiver. The transmitter has a language determination section and a transmission section. The language determination section determines a plurality of languages based on a setting of the transmitter. The transmission section transmits a plurality of pieces of data, each written in one of the plurality of determined languages that are different from each other. The receiver has a reception section and a display control section. The reception section receives the data. The display control section displays the data written in at least one of the plurality of languages.

According to another embodiment of the present disclosure, there is provided an information processor that transmits data to be displayed on a receiver and includes a language determination section and a transmission section. The language determination section determines a plurality of languages based on the setting of the information processor. The transmission section transmits the plurality of pieces of data. Of the plurality of pieces of data, the data written in at least one of the languages will be displayed on the receiver. Each of these pieces of data is written in one of the plurality of determined languages that are different from each other.

According to another embodiment of the present disclosure, there is provided an information processor that includes a reception section and a display control section. The reception section receives a plurality of pieces of data each of which is written in one of a plurality of languages. The languages are determined based on a setting of a device adapted to provide the data. The display control section displays the data written in at least one of the plurality of languages.

According to another embodiment of the present disclosure, there is provided an information processing method. The information processing method includes a transmitter determining a plurality of languages based on a setting of the transmitter. The information processing method includes the transmitter transmitting a plurality of pieces of data, each written in one of the plurality of determined languages that are different from each other. The information processing method includes a receiver receiving the data. The information processing method includes the receiver displaying the data written in at least one of the plurality of languages.

According to another embodiment of the present disclosure, there is provided a program for a computer transmitting information to be displayed on a receiver. The program for the computer determines a plurality of languages based on a setting of the computer. The program for the computer transmits the plurality of pieces of data. Of the plurality of pieces of data, the data written in at least one of the languages will be displayed on the receiver. These pieces of data are written, each in one of the plurality of determined languages that are different from each other.

According to another embodiment of the present disclosure, there is provided a program. The program for a computer determines a plurality of languages based on a setting of the computer. The program for the computer transmits a plurality of pieces of data. Of the plurality of pieces of data, the data written in at least one of the languages will be displayed on the receiver. These pieces of data are written, each in one of the plurality of determined languages that are different from each other.

The program can also be stored on a computer-readable storage media.

In the present disclosure, information in a plurality of languages determined based on the setting of a transmitter is transmitted, thus making it possible to strike a balance between ensuring readability of transmitted information and keeping traffic to a minimum during transmission of the information.

In one mode of the present disclosure, the language determination section determines, from among a plurality of predetermined languages, a plurality of languages that are a fraction of the plurality of predetermined languages based on the setting of the transmitter.

In another mode of the present disclosure, the display control section displays data written in the language determined based on the setting of the receiver.

In still another mode of the present disclosure, the language determination section determines the language that is associated with the setting of the transmitter in language association data that associates the settings and the languages. The display control section determines the language that is associated with the setting of the receiver in the language association data.

In still another mode of the present disclosure, the language determination section determines the language based on the position of the transmitter.

### BRIEF DESCRIPTION OF THE DRAWINGS

FIG. 1 is a diagram illustrating an example of overall configuration of an information processing system according to an embodiment of the present disclosure;

FIG. 2 is a diagram illustrating an example of appearance of an information processor according to the embodiment of the present disclosure;

FIG. 3 is a diagram illustrating an example of item message data;

FIG. 4 is a diagram illustrating an example of language association data;

FIG. 5 is a diagram illustrating an example of gift message data;

FIG. 6A is a diagram illustrating an example of a gift message image;

FIG. 6B is a diagram illustrating another example of a gift message image;

FIG. 6C is a diagram illustrating still another example of a gift message image;

FIG. 7 is a functional block diagram illustrating examples of functions implemented in the information processor according to the embodiment of the present disclosure;

FIG. 8A is a flowchart illustrating an example of flow performed in the information processor according to the present embodiment; and

FIG. 8B is a flowchart illustrating an example of flow performed in the information processor according to the present embodiment.

### DETAILED DESCRIPTION OF THE PREFERRED EMBODIMENT

A detailed description will be given below of an embodiment of the present disclosure with reference to the accompanying drawings.

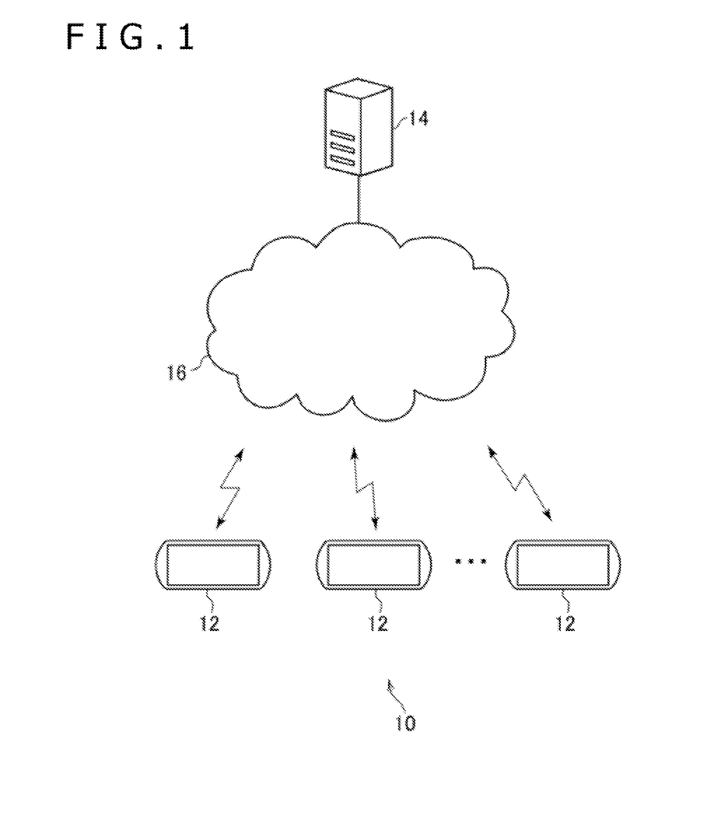

FIG. 1 is a diagram illustrating an example of overall configuration of an information processing system 10 according to an embodiment of the present disclosure. As illustrated in FIG. 1, the information processing system 10 according to the present embodiment includes, for example, an information processors 12 and a server 14. The information processors 12 and the server 14 are connected to a computer network 16 such as the Internet so that they can communicate with each other.

The information processor 12 according to the present embodiment is, for example, a computer such as battery-driven portable mobile game console. The server 14 according to the present embodiment is, for example, a server computer that relays data exchange between the information processors 12.

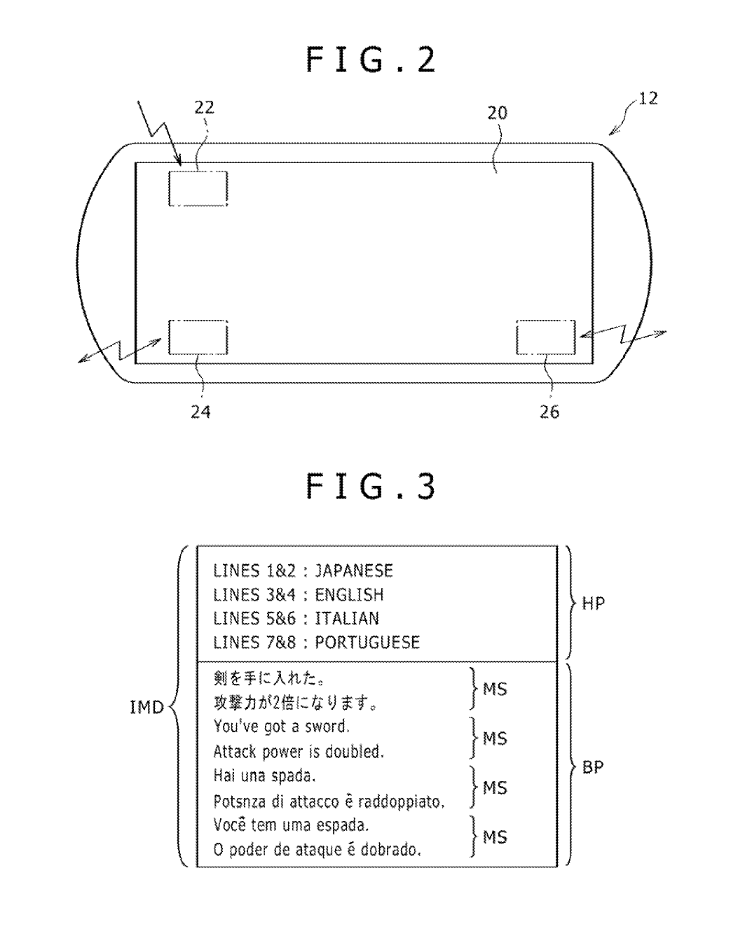

FIG. 2 is a diagram illustrating an example of appearance of the information processor according to the present embodiment. As illustrated in FIG. 2, the information processor 12 includes a touch screen on the front face. Further, the information processor 12 includes a positioning unit 22. The positioning unit 22 measures the position (latitude and longitude) of the information processor 12 using the GPS (Global Positioning System). Further, the information processor 12 incorporates a communication section adapted to communicate data. In the present embodiment, the information processor 12 incorporates, for example, as communication sections, a mobile phone communication unit 24 and a wireless Local Area Network (LAN) communication unit 26. The mobile phone communication unit 24 communicates data using a mobile phone network. The wireless LAN communication unit 26 communicates data using a wireless LAN. The information processor 12 can connect to the computer network 16 and communicate data to the server 14 by selectively using the mobile phone communication unit 24 or the wireless LAN communication unit 26 in accordance with the communication environment. In addition to the above, the information processor 12 further includes a control section, a storage section, and buttons. The control section is a program-controlled device such as Central Processing Unit (CPU) that operates in accordance with a program installed to the information processor 12. The storage section is, for example, a storage element such as Read Only Memory (ROM) or Random Access Memory (RAM), or a harddisk drive. The information processor 12 still further includes a touch pad on the back face.

We assume that the game program of a game named game A is, for example, installed to the information processor 12. The user of the information processor 12 can play game A as the information processor 12 executes the game program. Further, the information processor 12 according to the present embodiment repeatedly measures its own position using satellite signals and holds the measurement results thereof.

In the present embodiment, when the game program of game A is installed to the information processor 12, item data is stored in the information processor 12. Each piece of the item data is associated with one of a plurality of items that can be acquired while game A is played. Item data includes, for example, game identification information, item identification information, and item message data IMD illustrated in FIG. 3. FIG. 3 illustrates the item message data IMD included in item data associated with an item adapted to double the player's attack power. The item message data IMD according to the present embodiment includes a header portion HP and a body portion BP. The body portion BP includes a plurality of message character strings MS associated with the item. The plurality of message character strings MS are identical in contents but written in different languages. All the plurality of character strings MS illustrated in FIG. 3 mean that the player's attack power is doubled by the item. The header portion HP indicates the languages of the plurality of character strings MS included in the body portion BP and the positions where the character strings MS are arranged in the body portion BP. In the example illustrated in FIG. 3, the line numbers of the body portion BP where the character strings MS are arranged are shown in the header portion HP. However, the ranges from the top of the body portion BP in bytes may be shown. In the present embodiment, each of the character strings MS included in the item message data IMD is written in one of 20 predetermined languages. Then, in the present embodiment, the provider of the game program can select, at his or her pleasure, languages from among the 20 languages. Here, all the 20 languages may be selected as those in which to write the character strings MS.

Then, when an event occurs in which an item that can be provided to other user is acquired while game A is played, gift data associated with the item is transmitted to the server 14. The information processor 12 adapted to provide gift data, i.e., the information processor 12 that transmitted gift data to the server 14 here, will be hereinafter referred to as a transmitter 12a.

In the present embodiment, gift data associated with an item is generated based on item data associated with the item and language association data illustrated in FIG. 4. Language association data includes a plurality of combinations of a system language SL and a plurality of candidate languages CL associated with the system language SL. Here, the term “system language SL” refers to a language that can be specified in the information processor 12 according to the present embodiment and that is used in the information processor 12. It should be noted that the system language SL maybe a system menu language. On the other hand, the term “candidate language CL” refers to a candidate for a language used for the character string MS included in gift message data GMD that is included in gift data (refer to FIG. 5). In the present embodiment, each of the plurality of system languages SL is associated with six candidate languages CL (first to sixth candidate languages CL1 to CL6). In language association data according to the present embodiment, each of the candidate languages CL is associated with a rank. In the present embodiment, we assume that the first candidate language CL1 is ranked highest, and the sixth candidate language CL6 is ranked lowest.

FIG. 5 is a diagram illustrating an example of the gift message data GMD. FIG. 5 illustrates the gift message data GMD that is generated when an event occurs in which the player's attack power is doubled in the transmitter 12a whose system language SL is Japanese. The gift message data GMD according to the present embodiment includes the header portion HP and the body portion BP as does the item message data IMD. Further, gift data includes, for example, a user account name of the transmitter 12a, game identification information, item identification information, and so on in addition to the gift message data GMD.

In the present embodiment, when an event occurs in which an item is acquired, the gift message data GMD is generated that includes at least part of the character string MS that is included in the body portion BP of the item message data IMD associated with the item. More specifically, for example, the gift message data GMD is generated that includes, in the body portion BP, the character strings MS written in the candidate languages CL that are associated with the system language SL of the transmitter 12a. Further, in the present embodiment, the character strings MS are arranged in descending order of rank of the candidate language CL in the body portion BP of the gift message data GMD generated. In the present embodiment, the body portion BP of the gift message data GMD includes up to six character strings MS written in different languages. Then, information set in the header portion HP of the generated gift message data GMD indicates the languages of the plurality of character strings MS included in the body portion BP and the positions where the character strings MS are arranged in the body portion BP.

Then, in the present embodiment, the transmitter 12a transmits gift data to the server 14. The gift data includes the generated gift message data GMD. Then, the server 14 transmits the gift data, received from the transmitter 12a, to the other information processor 12. The information processor 12 that has received gift data from the server 14 will be hereinafter referred to as a receiver 12b. In the present embodiment, the receiver 12b serving as a destination of gift data transmitted from the transmitter 12a is determined based on the positional relationship between the transmitter 12a and the receiver 12b. The details of how the receiver 12b serving as a destination of gift data transmitted from the transmitter 12a is determined will be described later.

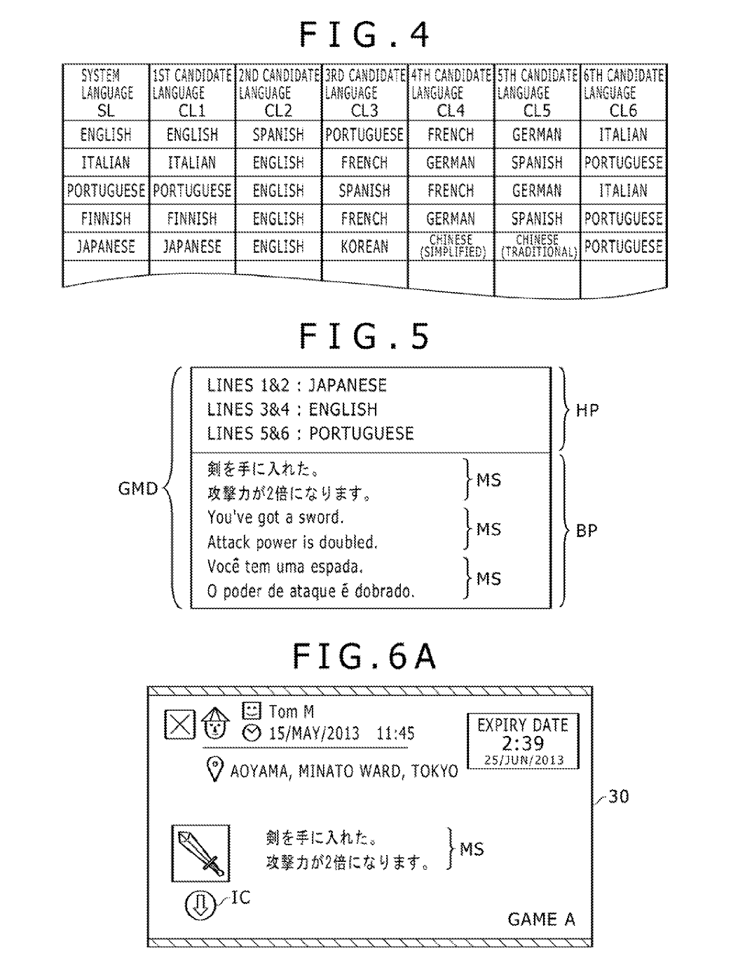

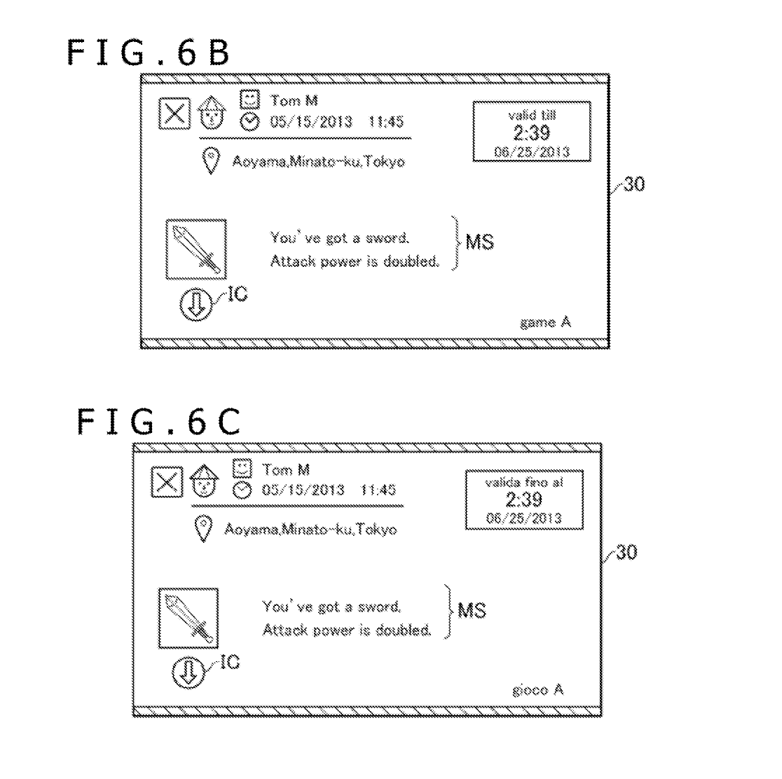

When the user of the receiver 12b that has received the gift data makes a given operation on a touch screen 20 of the receiver 12b, a gift message image 30 displays on the touch screen 20 (refer to FIGS. 6A, 6B, and 6C). FIG. 6A is a diagram illustrating an example of the gift message image 30 displaying on the touch screen 20 of the receiver 12b that has received the gift message data GMD illustrated in FIG. 5 and whose system language SL is Japanese. FIG. 6B is a diagram illustrating an example of the gift message image 30 displaying on the touch screen 20 of the receiver 12b that has received the gift message data GMD illustrated in FIG. 5 and whose system language SL is English. FIG. 6C is a diagram illustrating an example of the gift message image 30 displaying on the touch screen 20 of the receiver 12b that has received the gift message data GMD illustrated in FIG. 5 and whose system language SL is Italian. The gift message image 30 includes the character string MS of the message associated with the item.

As illustrated in FIGS. 6A and 6B, the character string MS is written in the system language SL in the receiver 12b whose system language SL is Japanese or English. In contrast, as illustrated in FIG. 6C, the character string MS is written in English in the receiver 12b whose system language SL is Italian despite the fact that the system language SL is Italian. Then, in the present embodiment, character strings other than the character string MS included in the gift message image 30 are written in the system language SL of the receiver 12b. The gift message image 30 further includes a download icon IC. The gift message image 30 still further includes the user account name of the transmitter 12a, the date and time of transmission of the gift data, the game title, the expiry date of the item, the address associated with position information that is associated with the gift data, the icon image of the item, and so on.

In the present embodiment, the character string MS in one language is selected from among the plurality of character strings MS included in the body portion BP of the gift message data GMD that is included in the gift data received by the receiver 12b. Then, the determined character string MS is included in the gift message image 30 that displays in the receiver 12b. In the present embodiment, the language association data illustrated in FIG. 4 is also used to determine the language of the character string MS included in the displayed gift message image 30. In the present embodiment, of the languages of the character strings MS included in the received gift message data GMD, the character string MS written in the language ranked highest among the candidate languages CL associated with the system language SL of the receiver 12b is included in the gift message image 30.

As described above, the transmitter 12a whose system language SL is Japanese generates the gift message data GMD illustrated in FIG. 5 based on the item message data IMD illustrated in FIG. 3. The item message data IMD illustrated in FIG. 3 includes the Japanese, English, Portuguese, and Italian character strings MS. Then, the language association data whose system language SL is Japanese includes, as candidate language CL values, Japanese, English, and Portuguese. However, Italian is not included. Therefore, the gift message data GMD illustrated in FIG. 5 includes the Japanese, English, and Portuguese character strings MS, but not the Italian character string MS.

Then, Japanese is included as the value of the first candidate language CL1 in the language association data whose value of the system language SL is Japanese. Then, the Japanese character string MS is included in the gift message data GMD illustrated in FIG. 5. As illustrated in FIG. 6A, therefore, the Japanese character string MS is included in the gift message image 30 in the receiver 12b that has received the gift message data GMD illustrated in FIG. 5 and whose system language SL is Japanese.

Further, English is included as the value of the first candidate language CL1 in the language association data whose value of the system language SL is English. Then, the English character string MS is included in the gift message data GMD illustrated in FIG. 5. As illustrated in FIG. 6B, therefore, the English character string MS is included in the gift message image 30 in the receiver 12b that has received the gift message data GMD illustrated in FIG. 5 and whose system language SL is English.

In the present embodiment, the system language SL is specified as the first candidate language CL1 associated with the system language SL in the language association data. Therefore, if the character string MS in the system language SL of the receiver 12b is included in the received gift message data GMD as described above, the character string MS in the system language SL is included in the gift message image 30.

However, the Italian character string MS is not included in the gift message data GMD illustrated in FIG. 5. Then, Italian is included as the value of the first candidate language CL1 in the language association data whose value of the system language SL is Italian. As illustrated in FIG. 6C, therefore, the English character string MS is included in the gift message image 30 in the receiver 12b that has received the gift message data GMD illustrated in FIG. 5 and whose system language SL is Italian.

Thus, in the present embodiment, even if the Italian character string MS is included in the item message data IMD, the Italian character string MS is not included in the gift message data GMD when the system language SL of the transmitter 12a is Japanese. Then, in this case, the Italian character string MS is not included in the gift message image 30 despite the fact that the system language SL is Italian in the receiver 12b that has received the gift message data GMD illustrated in FIG. 5.

Here, when the user of the receiver 12b taps the download icon IC included in the gift message image 30, data of an item that doubles the player's attack power, an item available in game A, is transmitted from the server 14 to the receiver 12b. As a result, the player's attack power is doubled in game A played by the user of the receiver 12b.

For example, when the gift message data GMD that includes only the character string MS in the system language SL of the transmitter 12a is transmitted to the receiver 12b, the receiver 12b can display the character string MS only in this language. This is inconvenient for the user of the receiver 12b. In the present embodiment, it is possible to display, on the touch screen 20 of the receiver 12b, the character string MS in the language that matches the system language SL of the receiver 12b among the plurality of character strings MS written in different languages. This provides improved message readability in the receiver 12b. Further, if a plurality of character strings MS written in different languages are transmitted, the larger the number of target languages, the larger the size of the character strings MS. This leads to increased traffic at the time of transmission of the character strings MS. In the present embodiment, the character string MS to be transmitted is limited to that in the language matching the system language SL of the transmitter 12a, thus keeping traffic to a minimum. As described above, the present embodiment can strike a balance between ensuring readability of transmitted message and keeping traffic to a minimum during transmission of the message.

Further, the larger the number of the character strings MS to be transmitted, the longer time it takes to transmit the character strings MS, which is inconvenient for the user of the transmitter 12a. The present embodiment keeps traffic to a minimum as described above, thus ensuring reduced time necessary for transmission of the character string MS. This provides improved convenience for the user of the transmitter 12a.

Further, in the present embodiment, the language in which to display the character string MS is determined by the receiver 12b. This contributes to reduced processing load as compared to if the language in which to display the character string MS is determined by the server 14.

Still further, the larger the number of character strings MS to be transmitted to the server 14, the more storage capacity is necessary for the server 14. In the present embodiment, the character string MS to be transmitted to the server 14 is limited to that in the language matching the system language SL of the transmitter 12a, ensuring saving in storage capacity of the server 14.

Still further, we assume, for example, that the server 14 selects the character string MS in the language that matches the system language SL of the receiver 12b and transmits the selected character string MS to the receiver 12b. In this case, if the number of languages that can be handled is changed, it is necessary for the administrator of the server 14 to perform management tasks such as changing the database schema and altering the program installed to the server 14. In the present embodiment, it is not necessary to manage the character strings MS included in the gift message data GMD in association with the languages in the server 14. As a result, it is not necessary to perform the above management tasks even if the number of languages that can be handled in the present embodiment is changed, that is, even if the number of character strings MS that can be included in the gift message data GMD is changed. Thus, the present embodiment contributes to reduced expense in time and effort in managing the server 14.

A description will be given below with primary focus on determining the language of the character string MS included in the gift message data GMD transmitted from the transmitter 12a to the server 14 and determining the language of the character string MS included in the gift message image 30 displayed on the receiver 12b.

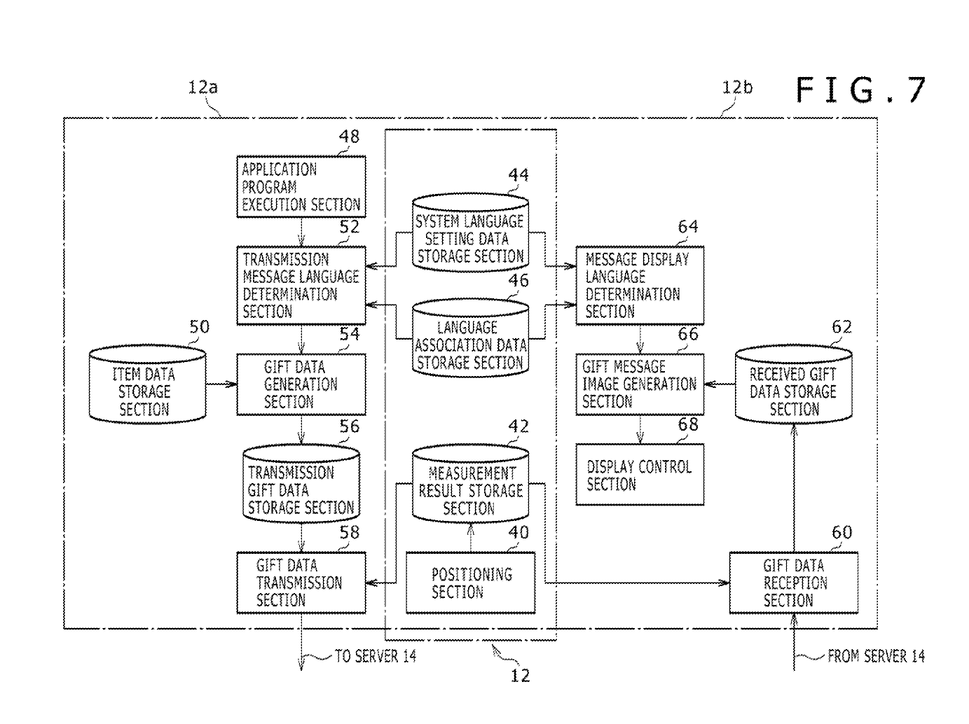

FIG. 7 is a functional block diagram illustrating examples of functions implemented in the information processor 12 according to the present embodiment. It should be noted that it is not necessary to implement all the functions illustrated in FIG. 7, and that functions other than those illustrated in FIG. 7 may be implemented.

Then, the information processor 12 according to the present embodiment functionally includes, for example, a positioning section 40, a measurement result storage section 42, a system language setting data storage section 44, a language association data storage section 46, an application program execution section 48, an item data storage section 50, a transmission message language determination section 52, a gift data generation section 54, a transmission gift data storage section 56, a gift data transmission section 58, a gift data reception section 60, a received gift data storage section 62, a message display language determination section 64, a gift message image generation section 66, and a display control section 68.

The positioning section 40 is implemented primarily as the positioning unit 22 of the information processor 12. The measurement result storage section 42, the system language setting data storage section 44, the language association data storage section 46, the item data storage section 50, the transmission gift data storage section 56, and the received gift data storage section 62 are implemented primarily as the storage section of the information processor 12. The application program execution section 48, the transmission message language determination section 52, the gift data generation section 54, the message display language determination section 64, the gift message image generation section 66, and the display control section 68 are implemented primarily as the control section of the information processor 12. The gift data transmission section 58 and the gift data reception section 60 are implemented primarily as the communication section of the information processor 12.

The positioning section 40, the measurement result storage section 42, the system language setting data storage section 44, the language association data storage section 46, the application program execution section 48, the item data storage section 50, the transmission message language determination section 52, the gift data generation section 54, the transmission gift data storage section 56, and the gift data transmission section 58 are functions relating to the information processor 12 as the transmitter 12a. The positioning section 40, the measurement result storage section 42, the system language setting data storage section 44, the language association data storage section 46, the gift data reception section 60, the received gift data storage section 62, the message display language determination section 64, the gift message image generation section 66, and the display control section 68 are functions relating to the information processor 12 as the receiver 12b.

Then, the above functions are implemented as the control section of the information processor 12 executes a program installed to the information processor 12, a computer. The program includes instructions associated with the above functions. The program is provided, for example, via a computer-readable information storage media such as optical disc, magnetic disk, magnetic tape, magneto-optical disk, or flash memory, or via the Internet.

The positioning section 40 activates the positioning unit 22 on a regular basis to receive a satellite signal (GPS signal), thus generating position coordinate data indicating position coordinates (latitude and longitude). When instructed explicitly by the user to perform positioning by using the touch screen 20, the positioning section 40 similarly generates position coordinate data. The positioning section 40 may generate position coordinate data based on not only identification information of wireless access points with which the wireless LAN communication unit 26 can communicate but also other necessary information.

The measurement result storage section 42 stores measurement results of the position of the own information processor 12 by the positioning section 40. In the present embodiment, the measurement result storage section 42 stores position coordinate data in association with the positioning date and time of the position coordinates indicated by the position coordinate data.

The system language setting data storage section 44 stores system language setting data indicating the system language SL of the information processor 12. The user can change the system language SL set in the system language setting data by operating the information processor 12.

The language association data storage section 46 stores the language association data illustrated in FIG. 4.

The application program execution section 48 executes an application program such as the game program of game A. An application program may be installed from a computer-readable information storage media such as CD-ROM or DVD-ROM that stores the application program to the information processor 12. Alternatively, an application program may be downloaded from other computer via the computer network 16 and installed to the information processor 12.

The item data storage section 50 stores item data of each of items associated with an event that occurs during the execution of an application program.

The transmission message language determination section 52 determines the language of the character string MS included in the gift message data GMD to be transmitted based on the system language SL indicated by the system language setting data and the language association data. The language of the character string MS included in the gift message data GMD to be transmitted will be hereinafter referred to as a transmission language. In the present embodiment, up to six transmission languages are determined.

In the present embodiment, as a rule, the candidate language CL associated with the system language SL is determined as a transmission language. However, there is a case in which item data including the character string MS in such a language in the item message data IMD is not stored in the item data storage section 50. In this case, the language of the character string MS ranked highest in the item message data IMD is specified as a virtual system language SLv. Then, the candidate language CL associated with the virtual system language SLv is determined as a transmission language.

The gift data generation section 54 generates gift data. The character string MS in the language determined by the transmission message language determination section 52 is included in the body portion BP of the gift message data GMD that is included in this gift data.

The transmission gift data storage section 56 stores gift data generated by the gift data generation section 54.

The gift data transmission section 58 transmits gift data, stored in the transmission gift data storage section 56, in association with position information. In the present embodiment, the gift data transmission section 58 transmits gift data in association with, for example, position coordinate data that is associated with the positioning date and time closest to the current date and time of all the pieces of position coordinate data stored in the measurement result storage section 42.

The server 14 according to the present embodiment manages position coordinates using regional IDs. A regional ID is information identifying each of mesh-shaped regions if a region to be managed (e.g., all regions on Earth) is divided into a number of meshes. Upon receipt of gift data from the information processor 12, the transmitter 12a, the server 14 identifies the regional ID of the region that includes the position coordinates indicated by the position coordinate data that is associated with the received gift data. Then, the server 14 stores gift data received in association with the identified regional ID.

The gift data reception section 60 receives gift data stored in the server 14 at a given time. In the present embodiment, the gift data reception section 60 transmits position coordinate data that is associated with the positioning date and time closest to the current date and time of all the pieces of position coordinate data stored in the measurement result storage section 42. As a result, the server 14 identifies the regional ID of the region that includes the position coordinates indicated by the position coordinate data that is associated with the received gift data. Then, the server 14 transmits, to the information processor 12, the receiver 12b, gift data stored in association with the identified regional ID. Then, the gift data reception section 60 of the information processor 12, the receiver 12b, receives the gift data. Thus, in the present embodiment, if the receiver 12b adapted to receive gift data and the transmitter 12a adapted to transmit gift data are close to each other in position, it is highly likely that gift data transmitted by the transmitter 12a is received by the receiver 12b.

The received gift data storage section 62 stores gift data received by the gift data reception section 60.

The message display language determination section 64 determines the language of the character string MS included in the gift message image 30 that is displayed based on the system language SL indicated by the system language setting data and the language association data. The language of the character string MS included in the gift message image 30 to be displayed will be hereinafter referred to as a display language.

In the present embodiment, as a rule, the candidate language CL associated with the system language SL is determined as a display language. However, there is a case in which the character string MS in such a language is not included in the gift message data GMD that is included in gift data received by the gift data reception section 60. In this case, the language of the character string MS ranked highest in the gift message data GMD is determined as a reception language.

The gift message image generation section 66 generates the gift message image 30 that includes the character string MS in the language determined by the message display language determination section 64 based on gift data stored in the received gift data storage section 62.

The display control section 68 displays the gift message image 30 generated by the gift message image generation section 66 on the touch screen 20.

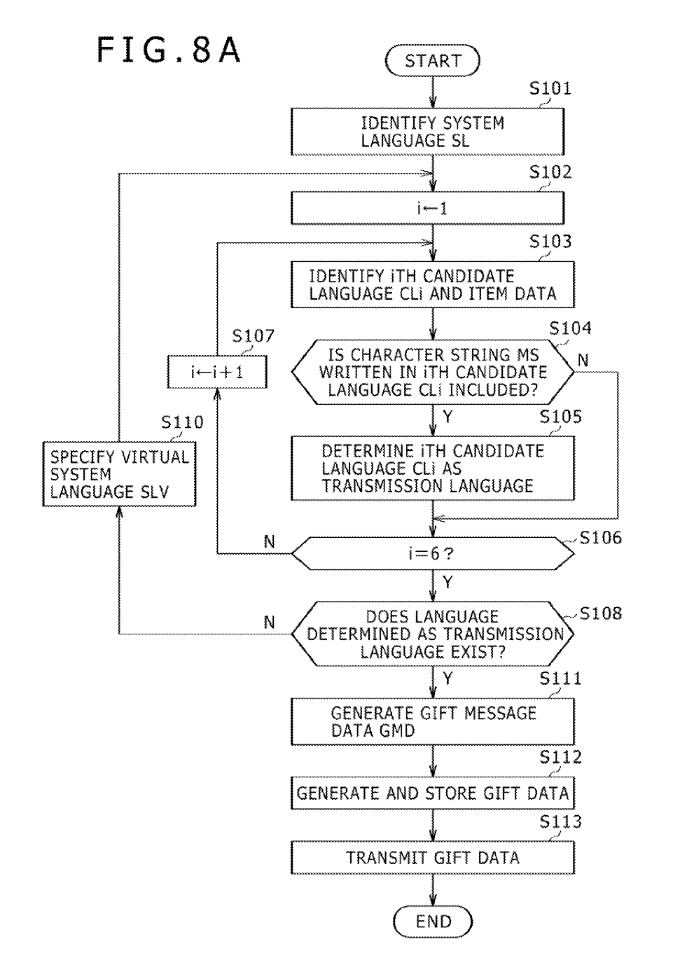

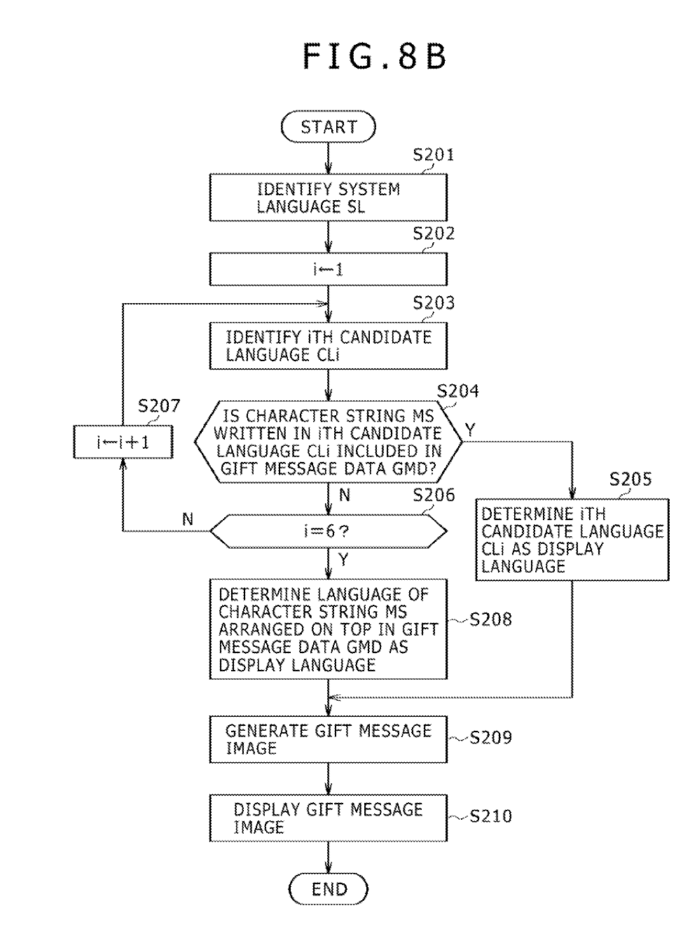

A description will be given here of an example of flow performed by the transmitter 12a according to the present embodiment when an event occurs in which an item adapted to double the player's attack power is acquired in the transmitter 12a with reference to the flowchart illustrated in FIG. 8A.

First, the transmission message language determination section 52 identifies the system language SL specified in the system language setting data stored in the system language setting data storage section 44 of the transmitter 12a (S101).

Then, the transmission message language determination section 52 sets “1” as the value of a variable i (S102). Then, the transmission message language determination section 52 identifies an ith candidate language CLi associated with the system language SL identified by the process illustrated in S101 in the language association data and item data associated with the item (S103). Then, the transmission message language determination section 52 verifies whether or not the character string MS written in the ith candidate language CLi identified by the process illustrated in S103 is included in the item message data IMD of the item data identified by the process illustrated in S103 (S104). If the character string MS is included in the item message data IMD (Y in S104), the transmission message language determination section 52 determines the ith candidate language CLi as a transmission language (S105).

If it is verified in the process illustrated in S104 that the character string MS is not included in the item message data IMD (N in S104), or if the process illustrated in S105 is terminated, the transmission message language determination section 52 verifies whether or not the value of the variable i is “6” (S106). If it is verified that the value of the variable i is not “6” (N in S106), the transmission message language determination section 52 increments the value of the variable i by 1 (S107), and performs the processes from S103 and beyond again. If it is verified that the value of the variable i is “6” (Y in S106), the transmission message language determination section 52 verifies whether or not the language determined as a transmission language in the process illustrated in S105 exists (S108). If the language does not exist (N in S108), the transmission message language determination section 52 specifies the system language SL (virtual system language SLv) used in the present process example as the language in which the highest ranked character string MS is written of all the character strings MS indicating a message about the item (S110). It should be noted that the setting of the system language setting data stored in the system language setting data storage section 44 of the transmitter 12a is not changed here. Then, the transmitter 12a performs the processes from S102 and beyond again. In this case, the ith candidate language CLi associated with the virtual system language SLv is identified in the process illustrated in S103.

If it is verified in the process illustrated in S108 that the language determined as a transmission language in the process illustrated in S105 exists (Y in S108), the gift data generation section 54 generates the gift message data GMD (S111). The process illustrated in Sill generates the gift message data GMD that includes the character string MS in the language determined as a transmission language in the process illustrated in S105. Further, the higher the rank of the candidate language CL of the character string MS, the higher the character string MS is arranged in the body portion BP of the generated gift message data GMD.

Then, the gift data generation section 54 generates gift data that includes the gift message data GMD generated in the process illustrated in S110 and stores the gift data in the transmission gift data storage section 56 (S112). Then, the gift data transmission section 58 transmits the gift data stored in the process illustrated in S112 to the server 14 in association with position coordinate data (S113) and terminates the processes illustrated in the present process example. 11 be given next of an example of flow performed by the receiver 12b according to the present embodiment when the user of the receiver 12b makes an operation adapted to display the gift message image 30 on the touch screen 20 of the receiver 12b with reference to the flowchart illustrated in FIG. 8B. In the present process example, we assume that the gift message data GMD associated with the gift message image 30 to be displayed is stored in the received gift data storage section 62.

First, the message display language determination section 64 identifies the system language SL specified in the system language setting data stored in the system language setting data storage section 44 of the receiver 12b (S201). Then, the message display language determination section 64 sets “1” as the value of the variable i (S202). Then, the message display language determination section 64 identifies the ith candidate language CLi associated with the system language SL identified in the language association data (S203). Then, the message display language determination section 64 verifies whether or not the character string MS written in the ith candidate language CLi is included in the gift message data GMD stored in the received gift data storage section 62 (S204). If the character string MS is included in the gift message data GMD (Y in S204), the message display language determination section 64 determines the ith candidate language CLi as a display language (S205). If the character string MS is not included in the gift message data GMD (N in S204), the message display language determination section 64 verifies whether or not the value of the variable i is “6” (S206). If it is verified that the value of the variable i is not “6” (N in S206), the message display language determination section 64 increments the value of the variable i by 1 (S207), and performs the processes from S203 and beyond again. If it is verified that the value of the variable i is “6” (Y in S206), the message display language determination section 64 determines the language of the character string MS at the top in the gift message data GMD as a display language (S208).

Then, the gift message image generation section 66 generates the gift message image 30 that includes the character string MS in the language determined in the process illustrated in S205 or S208 that is included in the body portion BP of the gift message data GMD (S209). Then, the display control section 68 displays the gift message image 30 generated in the process illustrated in S209 on the touch screen 20 (S210).

It should be noted that the present disclosure is not limited to the above embodiment.

In the present embodiment, gift data transmitted by the transmitter 12a is received by the receiver 12b located nearby. For example, therefore, when an Italian visits Japan as a tourist, the gift message data GMD transmitted by the information processor 12 used by the Italian to the server 14 is highly likely received by the information processor 12 used by a Japanese. Focusing on this point, the transmission message language determination section 52 may, for example, determine, as a language of the character string MS included in the gift message data GMD, the language used in the area to which the position of the transmitter 12a belongs. More specifically, for example, the language of the area that includes the position coordinates indicated by the position coordinate data with the most recent positioning date and time stored in the measurement result storage section 42 of the transmitter 12a may be treated as the first candidate language CL1.

This ensures that the character string MS in the language used in the area to which the position of the transmitter 12a matching the most recent measurement result belongs is included in the gift message data GMD transmitted by the transmitter 12a to the server 14. Then, when the receiver 12b located in this area receives the gift message data GMD, the character string MS can be displayed in the language used in that area. This provides improved readability of the character string MS of the displayed message.

Further, for example, the message display language determination section 64 may determine a plurality of languages for the character string MS included in the gift message image 30 to be displayed. Then, the display control section 68 may display the gift message image 30 with the character strings MS in the plurality of languages on the touch screen 20.

Still further, the sharing roles by the information processor 12 and the server 14 is not limited to the above. For example, the transmitter 12a may transmit item data stored in the item data storage section 50 and associated with an event that has occurred. Then, the server 14 may determine up to six languages of the character strings MS included in the gift message data GMD transmitted to the receiver 12b based on the system language SL of the transmitter 12a. Then, the server 14 may generate gift data based on the determined languages and received item data and transmit the gift data to the receiver 12b. Further, for example, the server 14 may determine the languages of the character strings MS included in the gift message data GMD to be transmitted to the receiver 12b based on the system language SL of the receiver 12b. Then, the server 14 may transmit the gift message data GMD including the character strings MS to the receiver 12b.

Further, it is not necessary to exchange gift data via the server 14. Gift data may be transmitted from the transmitter 12a to the receiver 12b, for example, by peer-to-peer (P2P) technique.

Further, the present embodiment can be used for applications other than exchange of messages regarding items. The present embodiment can be used, for example, to determine languages in which to write a routine message transmitted to other users in response to an explicit operation of the user.

Still further, the information processor 12 may be a personal computer, a tablet terminal, a smartphone, or other device. Still further, the information processor 12 may include a plurality of enclosures. Alternatively, the server 14 may include a plurality of enclosures.

Further, the above specific character strings and those in the drawings are illustrative, and the present disclosure is not limited to these character strings.

The present disclosure contains subject matter related to that disclosed in Japanese Priority Patent Application JP 2013-120272 filed in the Japan Patent Office on Jun. 6, 2013, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system comprising:
a transmitter; and
a receiver, wherein
the transmitter includes
a language determination section adapted to determine a plurality of languages based on a setting of the transmitter, and
a transmission section adapted to transmit a plurality of pieces of data, each written in one of the plurality of determined languages that are different from each other, and
the receiver includes
a reception section adapted to receive the data, and
a display control section adapted to display the data written in at least one of the plurality of languages.

2. The information processing system of claim 1, wherein
the language determination section determines, from among a plurality of predetermined languages, a plurality of languages that are a fraction of the plurality of predetermined languages based on the setting of the transmitter.

3. The information processing system of claim 1, wherein
the display control section displays data written in the language determined based on the setting of the receiver.

4. The information processing system of claim 1, wherein
the language determination section determines the language that is associated with the setting of the transmitter in language association data that associates the settings and the languages, and
the display control section determines the language that is associated with the setting of the receiver in the language association data.

5. The information processing system of claim 1, wherein
the language determination section determines the language based on the position of the transmitter.

6. An information processor transmitting data to be displayed on a receiver, the information processor comprising:
a language determination section adapted to determine a plurality of languages based on a setting of the information processor; and
a transmission section adapted to transmit the plurality of pieces of data, of which the data written in at least one of the languages will be displayed on the receiver, with each of these pieces of data being written in one of the plurality of determined languages that are different from each other.

7. An information processor comprising:
a reception section adapted to receive a plurality of pieces of data each of which is written in one of a plurality of languages, the languages being determined based on a setting of a device adapted to provide the data; and
a display control section adapted to display the data written in at least one of the plurality of languages.

8. An information processing method comprising:
determining, executed by a transmitter, a plurality of languages based on a setting of the transmitter;
transmitting, executed by the transmitter, a plurality of pieces of data each of which is written in one of the plurality of determined languages that are different from each other;
receiving, executed by a receiver, the data; and
displaying, executed by the receiver, the data written in at least one of the plurality of languages.

9. A program for a computer transmitting information to be displayed on a receiver, comprising:
determining a plurality of languages based on a setting of the computer; and
transmitting the plurality of pieces of data of which the data written in at least one of the languages will be displayed on the receiver, with each of these pieces of data being written in one of the plurality of determined languages that are different from each other.

10. A computer-readable information storage media storing a program for a computer transmitting information to be displayed on a receiver, the program including:
determining a plurality of languages based on a setting of the computer; and
transmitting the plurality of pieces of data of which the data written in at least one of the languages will be displayed on the receiver, with each of these pieces of data being written in one of the plurality of determined languages that are different from each other.

11. A program for a computer, comprising:
determining a plurality of languages based on a setting of the computer; and
transmitting the plurality of pieces of data, the data written in at least one of the languages will be displayed on the receiver, with each of these pieces of data being written in one of the plurality of determined languages that are different from each other.

12. A computer-readable information storage media storing a program for a computer, the program including:
determining a plurality of languages based on a setting of the computer; and
transmitting the plurality of pieces of data, the data written in at least one of the languages will be displayed on the receiver, with each of these pieces of data being written in one of the plurality of determined languages that are different from each other.
